(19) United States
(12) Patent Application Publication
(10) Pub. No.: US 2010/0293712 A1
(43) Pub. Date: Nov. 25, 2010

(54) STRETCHER

(75) Inventor: Luigi Cesare Pizzi Spadoni, Collecchio (Parma) (IT)

Correspondence Address: YOUNG & THOMPSON, 209 Madison Street, Suite 500, Alexandria, VA, 22314, US

(73) Assignee: SPENCER ITALIA S.R.L., Collecchio (Parma) (IT)

(21) Appl. No.: 12/446,021

(22) PCT Filed: Oct. 19, 2007
(86) PCT No.: PCT/IB07/03138

§ 371 Date: Apr. 17, 2009

(30) Foreign Application Priority Data
Oct. 20, 2006 (IT) PR2006A000093

(51) Int. Cl. A61G 1/02; A61G 1/06; A61G 1/056

(52) U.S. Cl. 5/86.1

(57) ABSTRACT

The invention finds application in the field of ambulance transport, emergency transport and other transport equipment. It relates to a stretcher (1) of the type comprising an upper frame (2) with a articulated platform (3) mounted thereto; a from loading carriage (4). The stretcher (1) has at least one additional rear leg (9) and a corresponding support (10) for holding said rear leg (9) against the upper frame (2), in such a manner as to be suspended between the front loading carriage (4) and the additional rear leg (9) during loading and unloading. The provision of a motor-driven coupling system/device allows automatic loading and unloading of said stretcher (1).

The present invention relates to a stretcher, e.g. for use in ambulances, funeral transport, or elsewhere.

Self-loading ambulance stretchers have a platform on which the patient is laid, and a frame for supporting said platform, which in turn has legs with free wheels for transfer thereof.

As the stretcher is loaded onto the ambulance, the operator has to push it along the ambulance floor, wherefore the legs have to be somehow folded against the frame; this can be accomplished manually (according to a rather obsolete practice), or using special arrangements, such as hinging the legs under the floor for later unlocking thereof towards the floor by suitable hydraulic or mechanical or electric devices as the stretcher is pushed by the operator.

In another type of stretcher the wheels are mounted to a lower frame, which is connected to the upper frame, the platform being fixed thereto by one or more scissor-lift systems: thus, the loading step is carried out by laying the front of the stretcher, usually equipped with additional wheels, on the ambulance floor and by causing the stretcher to collapse by folding the above mentioned scissor-lift, i.e. by lifting the lower frame against the upper frame until the free wheels of the lower frame are flush with the ambulance frame, whereby the operator can push the collapsed stretcher into the ambulance.

Concerning this action, a major drawback arises in that at least two operators are needed, with the former holding one end of the stretcher (the other end already lying by suitable front loading wheels on the ambulance floor), and the latter moving the lower frame towards the main frame, thereby folding the scissor-lift system. The same drawback arises when the stretcher has to be unloaded from the ambulance.

Furthermore, while one operator operates the scissor-lift, the other has to support the combined weight of the stretcher and the patient lying thereon, and with time this may cause the operator to suffer pain o injury.

The object of the present invention is to allow loading and unloading of stretchers of the type using scissor-lift systems, by one operator, by the provision of an additional wheel behind the stretcher which is designed to support the stretcher end, by suitable means, while the operator folds the scissor-lift system

The advantages achieved by such invention consist in that one operator can handle the whole transport operation, and is not required to support the weight of the person to be loaded during loading and unloading.

In other words, the invention can considerably reduce the load on the operator and any risk that he/she may suffer injury as a result of the above operation.

These objects and advantages for patient and operator safety are achieved by the stretcher of this invention, which is characterized by the content of the annexed claims.

These and other features will be more apparent from the following description of a few embodiments, which are shown by way of example and without limitation in the accompanying drawings, in which:

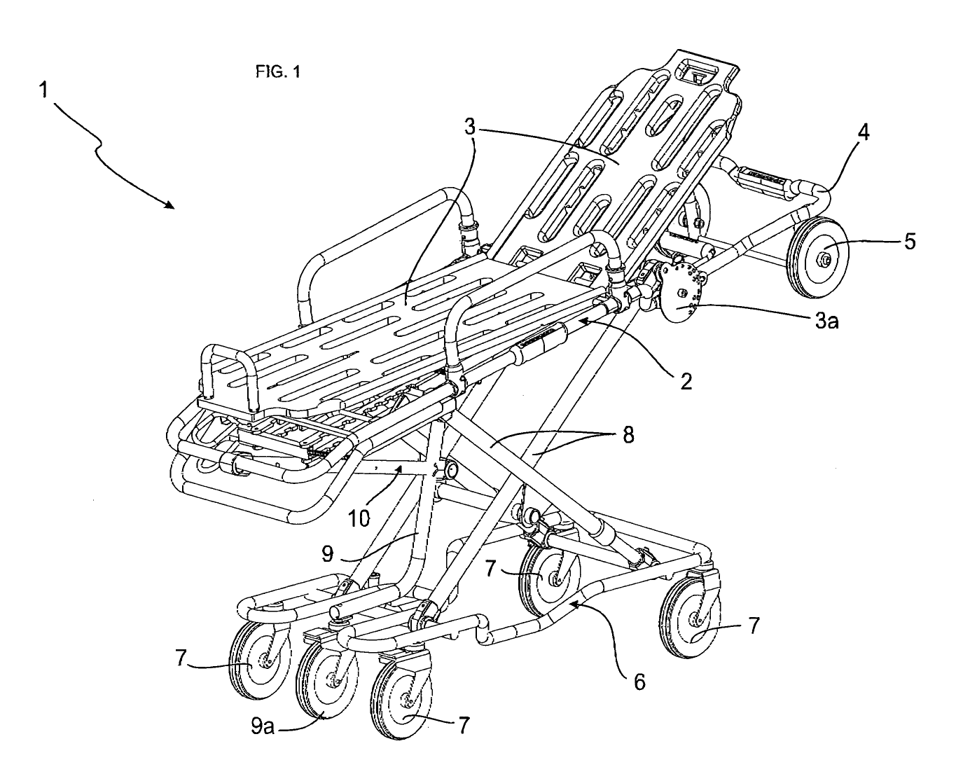

FIG. 1 is a perspective view of the stretcher of this invention;

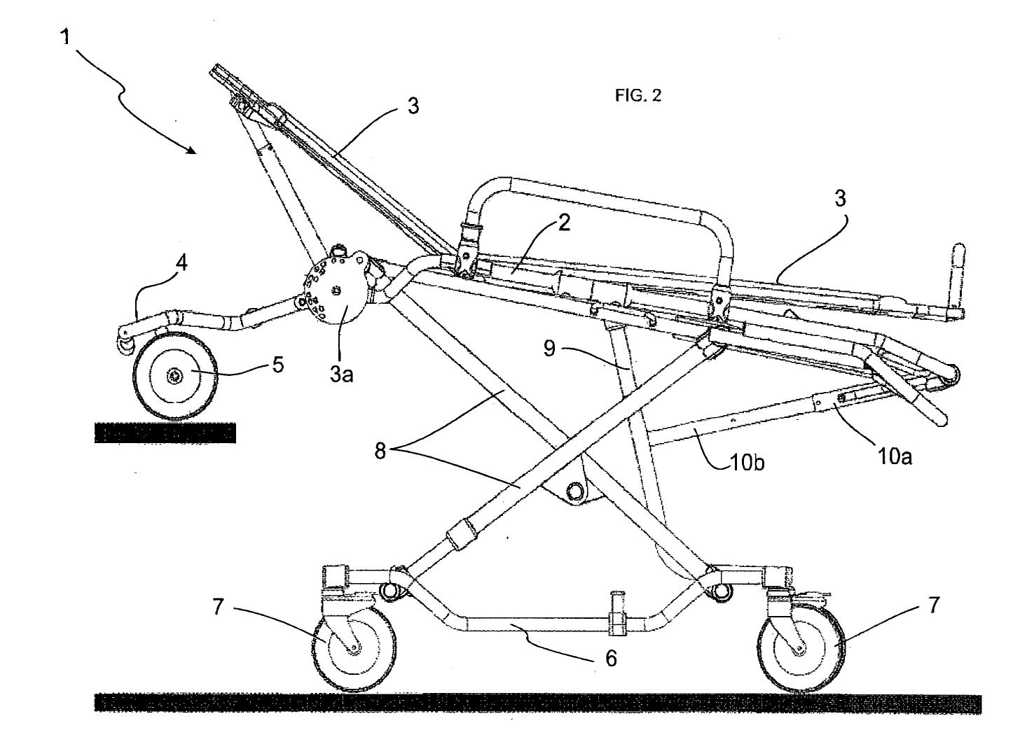

FIG. 2 illustrates the first step for loading the stretcher of FIG. 1 onto an ambulance;

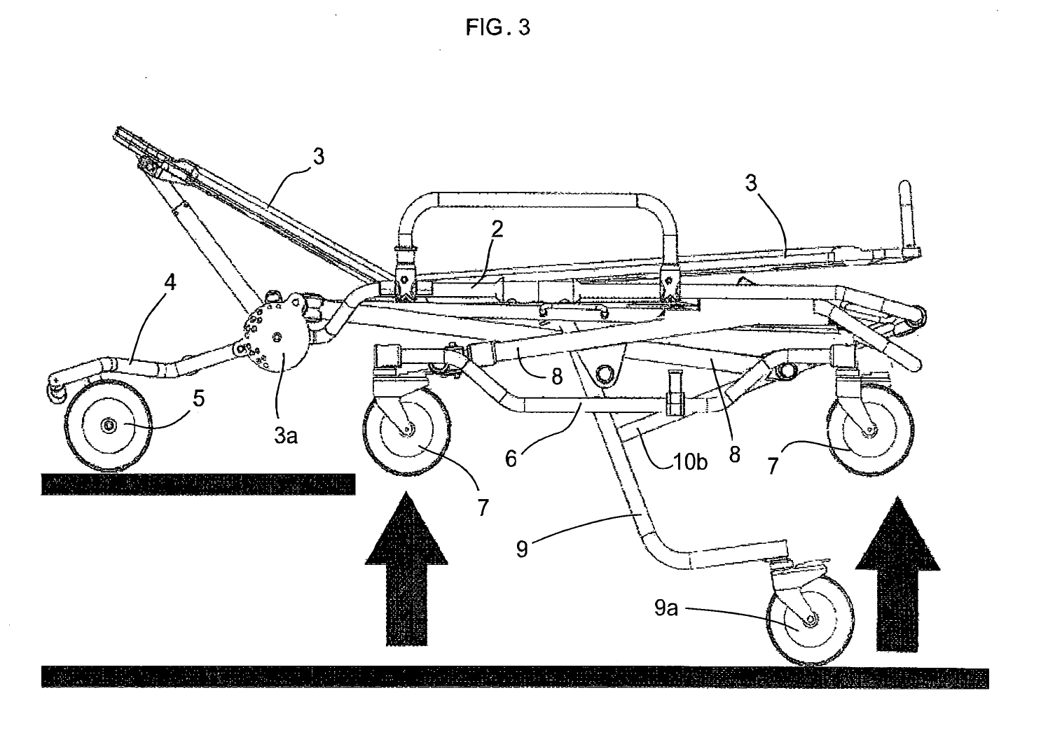

FIG. 3 illustrates the second step for loading the stretcher of FIG. 1 onto an ambulance;

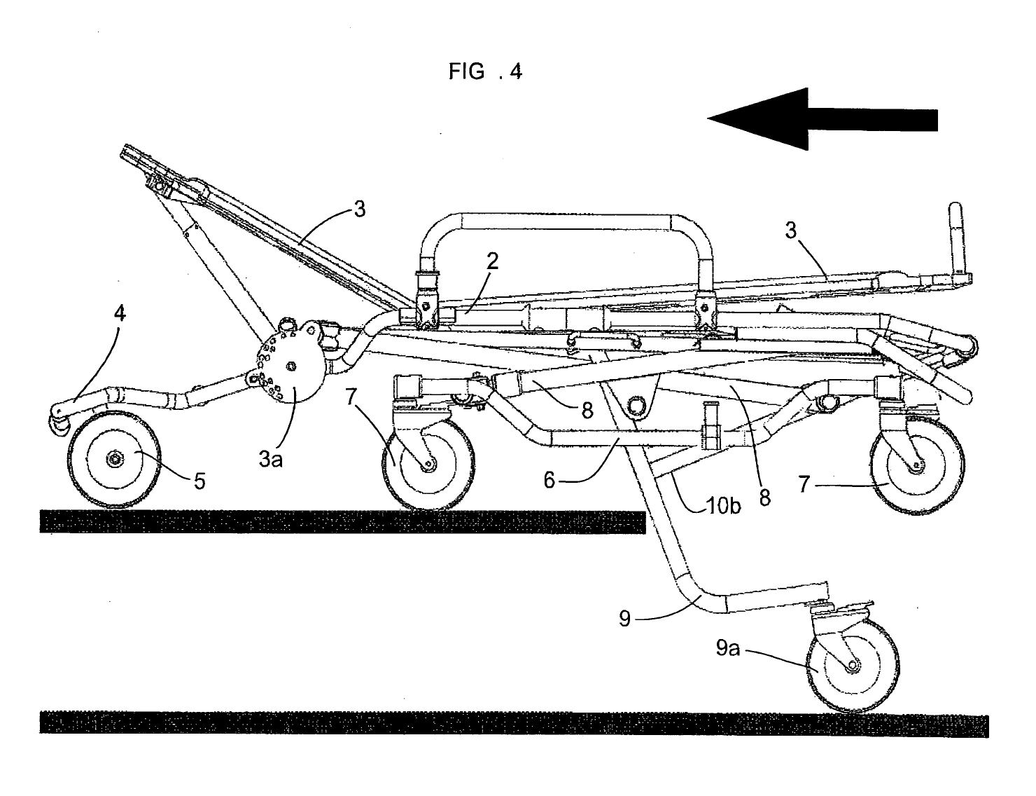

FIG. 4 illustrates the third step for loading the stretcher of FIG. 1 onto an ambulance;

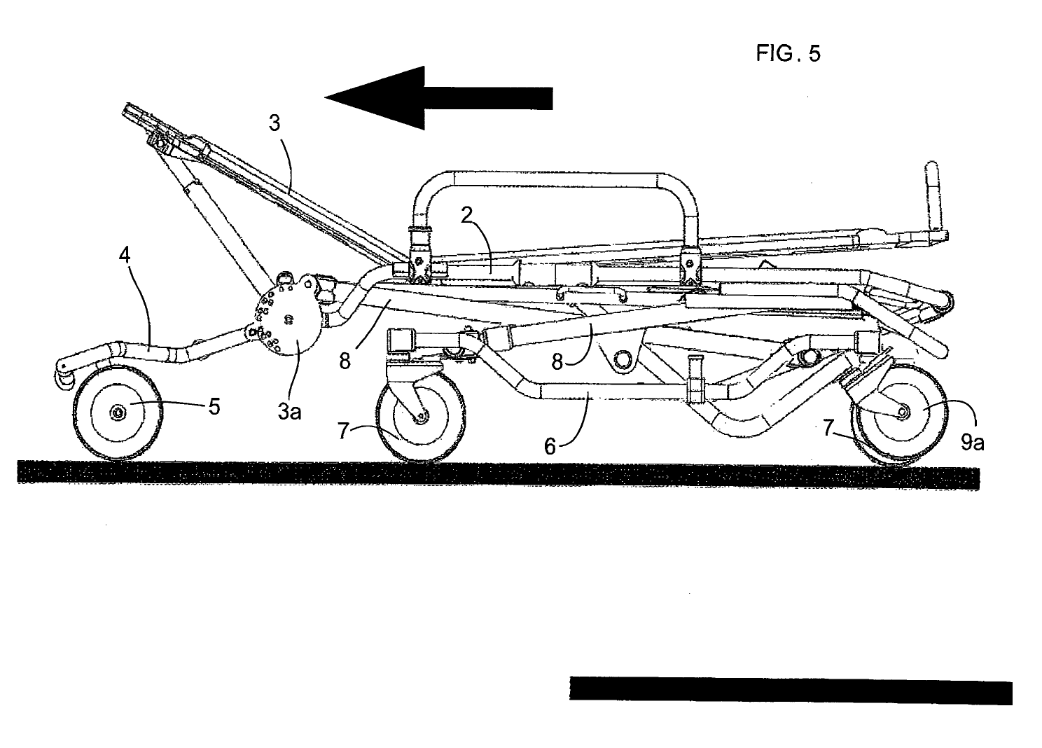

FIG. 5 illustrates the fourth step for loading the stretcher of FIG. 1 onto an ambulance;

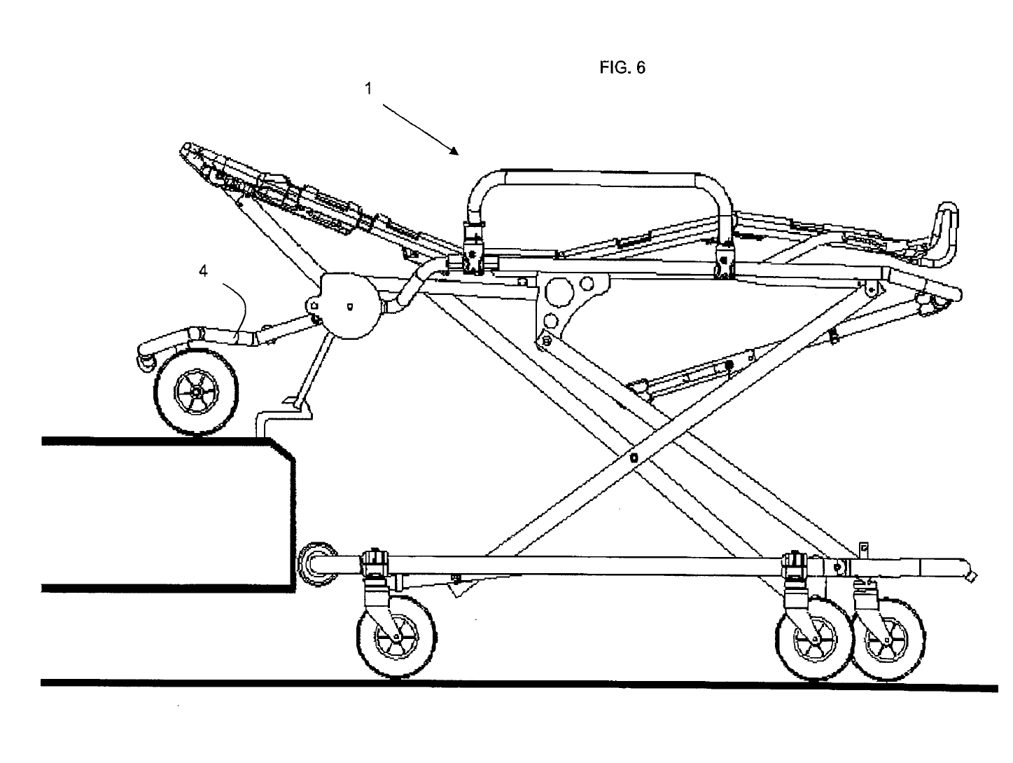

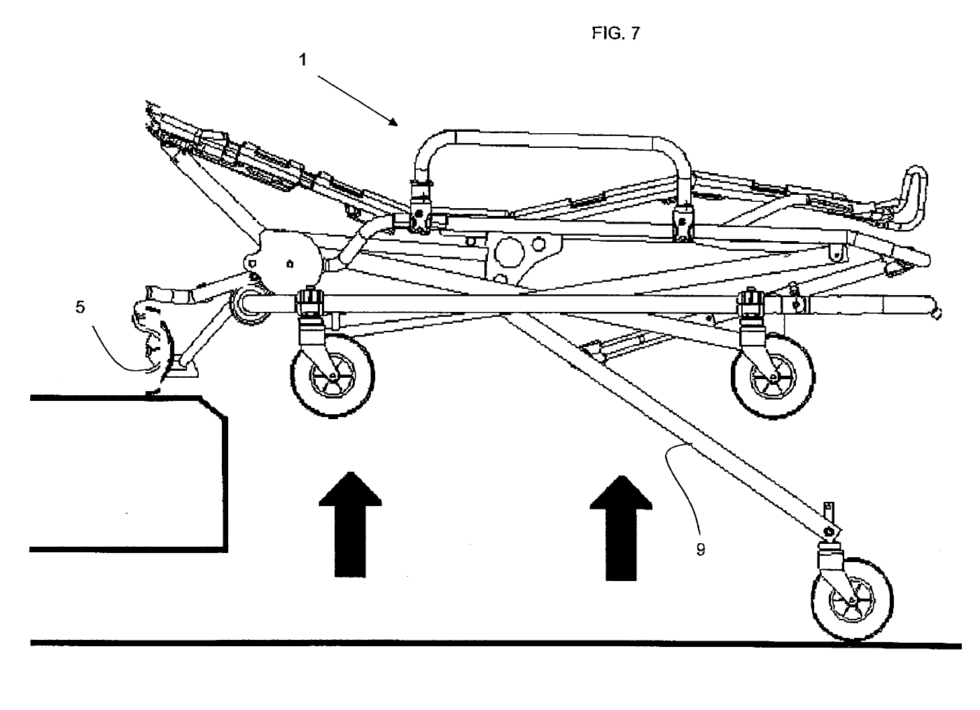

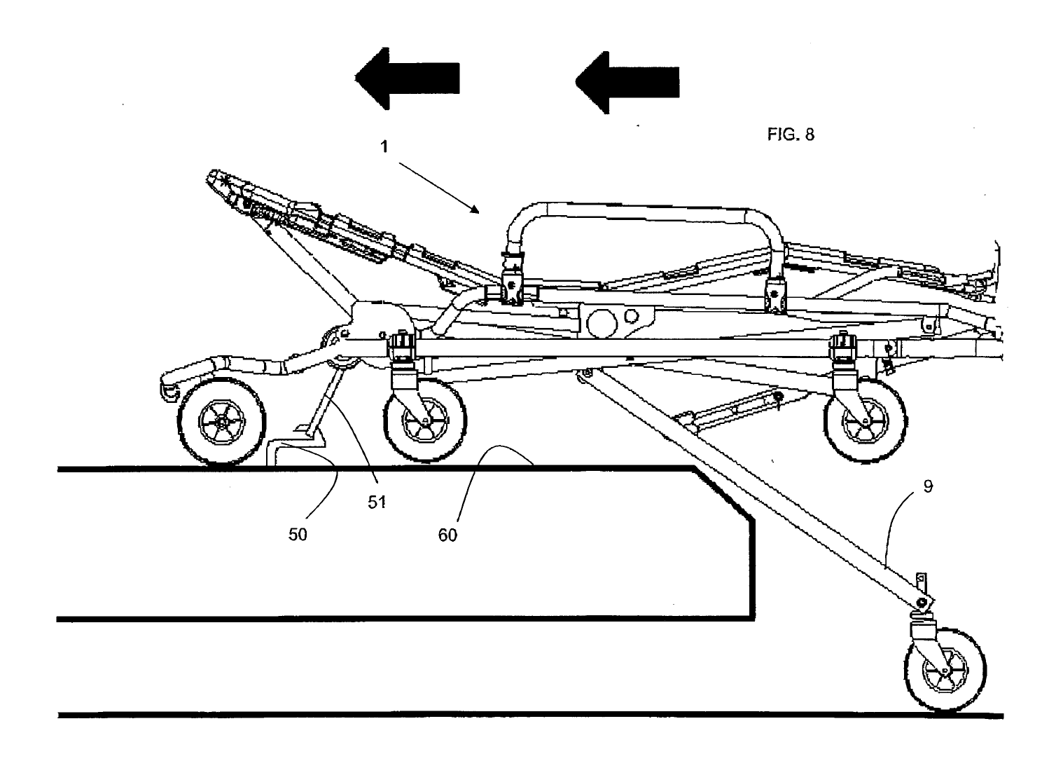

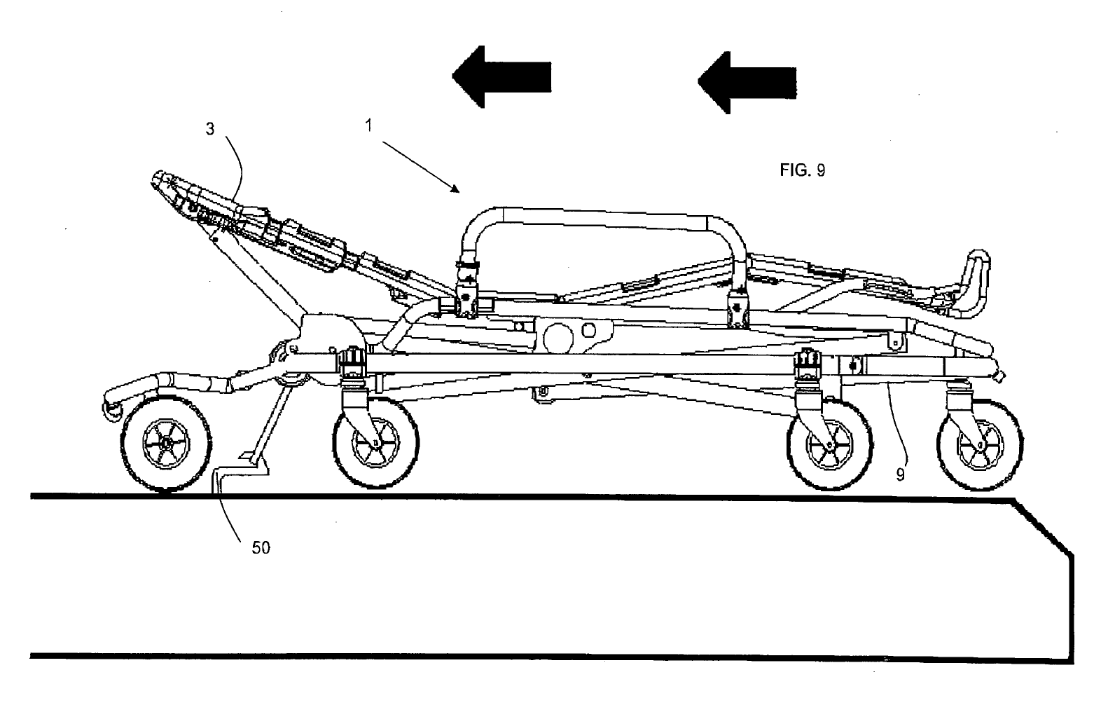

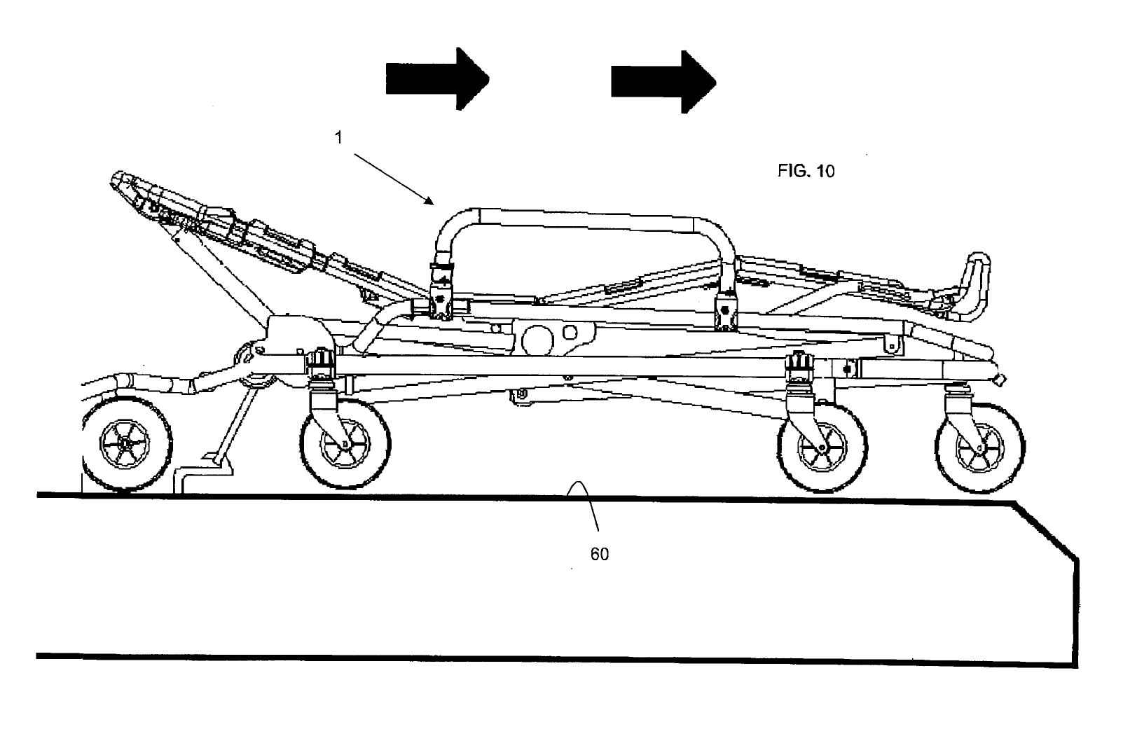

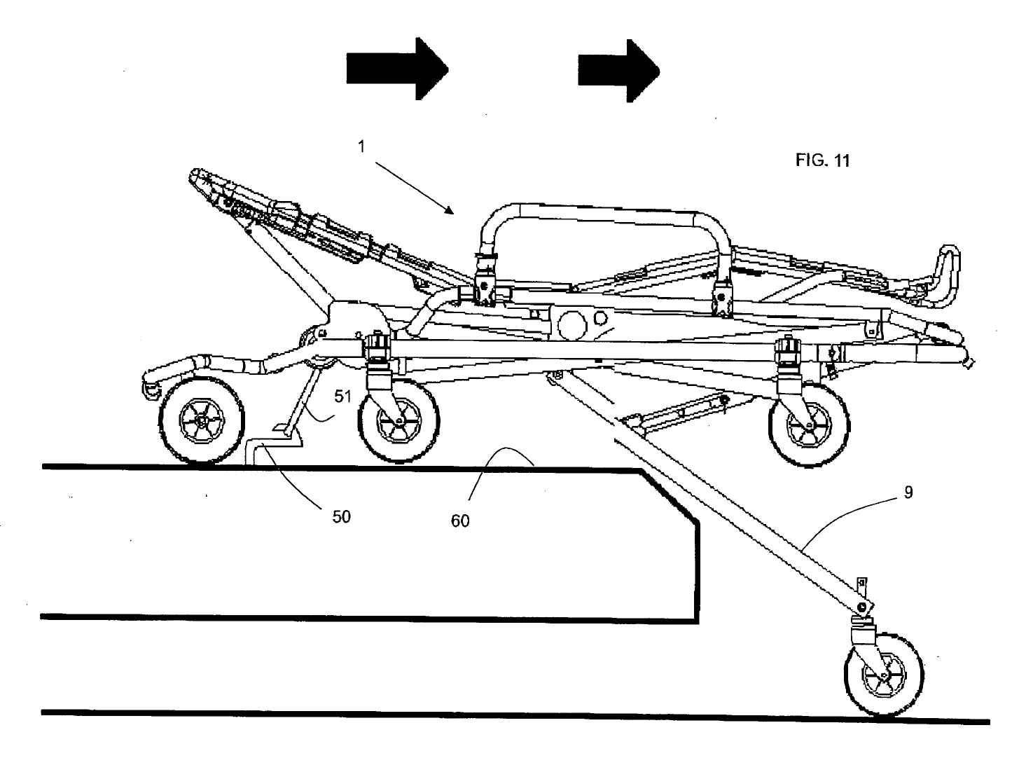

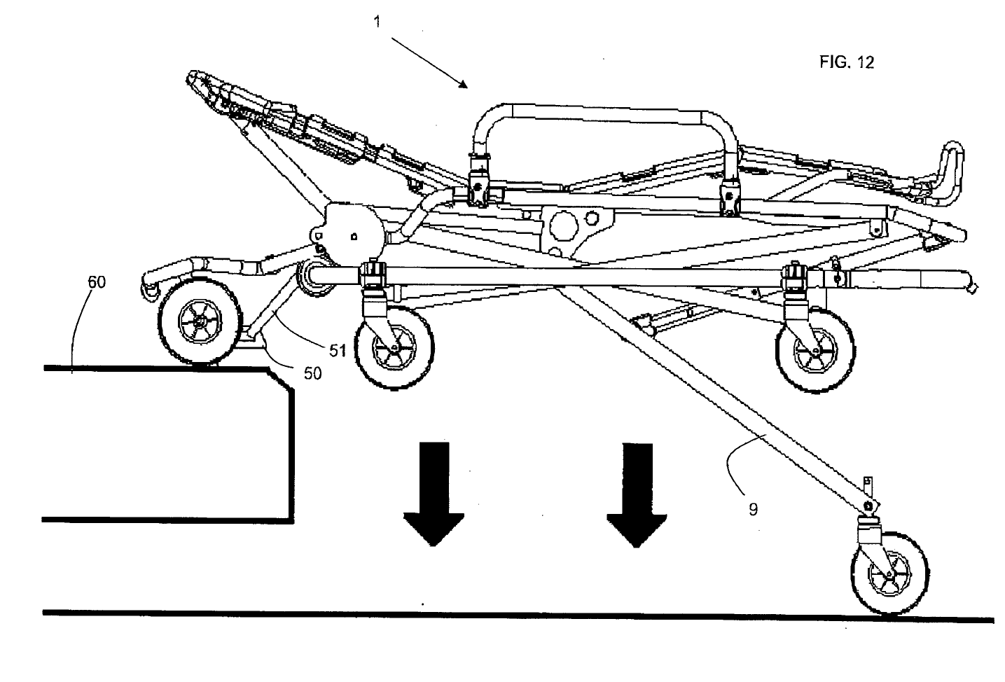

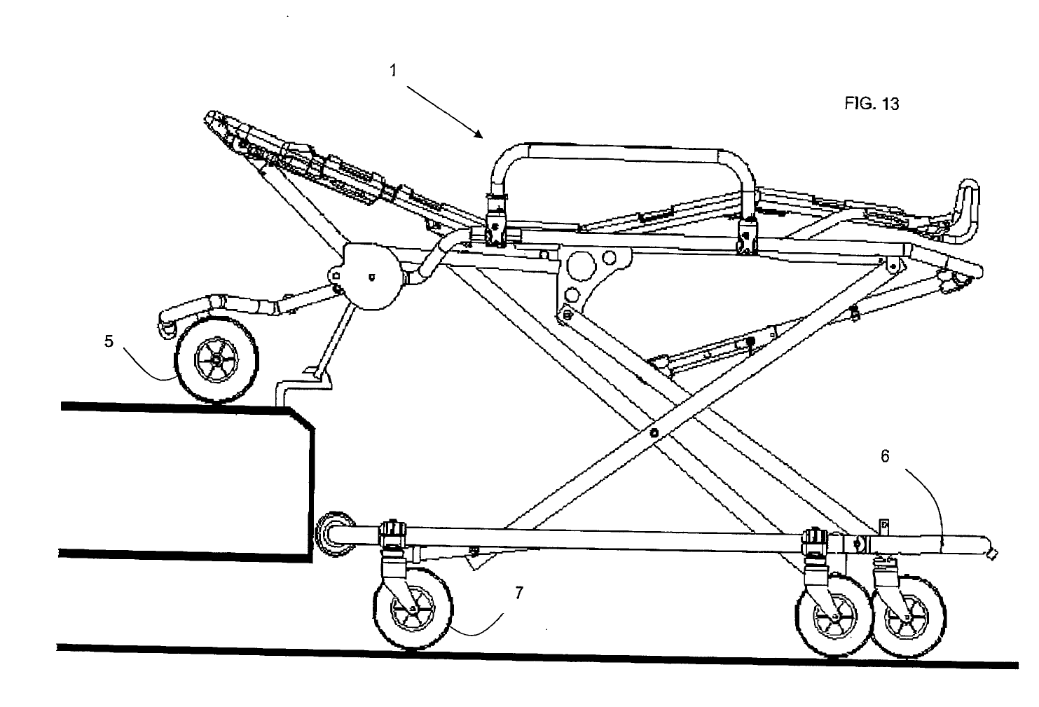

FIGS. 6, 7, 8, 9, 10, 11, 12 and 13 illustrate an alternative solution to the loading and unloading of the present stretcher, in which a motor-driven coupling system is provided on the floor of the loading means, such as the ambulance.

Referring to FIG. 1, numeral 1 generally designates a stretcher comprising an upper frame 2 with an articulating, i.e. tiltable platform 3 mounted thereto.

A front loading carriage 4 is fixed to the upper frame 2, and its tilt relative to the upper frame 2 can be adjusted by a suitable adjustment disk 3a or any other equivalent system.

A pair of free wheels 5 is attached to said front loading carriage 4, for supporting the stretcher 1 on the ambulance floor during loading.

The lower frame 6 is also shown to have four free wheels 7, and to be connected with the upper frame through a scissor-lift 8, substantially formed of two cylinders in crossed relationship, attached to the respective frames 2 and 6. A rod may slide in these cylinders so that, by lifting the lower frame 6, or by controlling the rod motion in the cylinder, the scissor-lift 8 collapses and the frames 2 and 6 move towards each other, thereby reducing the height of the stretcher without changing the position of the free wheels 7.

Once the lower frame 6 comes close to the upper frame 2, it may be optionally locked thereto by suitable locking means.

The stretcher 1 further has an additional rear loading leg 9 in hinged relationship with the upper frame under the platform 3.

A support wheel 9a is fixed to the lower end of said rear loading leg 9 for supporting and transferring the stretcher 1 when the two lower and upper frames are closer together, as shown in FIG. 3.

A locking system 10 joins said rear loading leg 9 to the frame 2, at the crossmember placed on the push side of the stretcher 1.

As better shown from FIG. 2 and the following Figures, said locking system 10 is practically composed of a cylinder 10a in which a rod 10b slides as the rear leg moves up.

Indeed, the locking system 10 has the function to lock the rear loading leg 9 to the ground for the stretcher 1 to be only suspended between the front loading carriage 4 and the rear loading leg 9, which allows operation on the lower frame 6, and displacement thereof against the upper frame 2 during loading in and unloading from the ambulance.

The rod 10b and the cylinder 10a are locked together by suitable lock means, of the manual, mechanical, hydraulic or electric type.

Referring to FIGS. 2, 3, 4 and 5, there are shown the steps to be carried out for loading the stretcher 1 of this invention onto the ambulance floor.

First, the front loading carriage 4 is laid on such floor whereupon, as the stretcher is lowered, the locking system 10 with its lock means is moved close to the stretcher 1 and lifts the lower frame 6 thereby folding the scissor-lift 8: thus 1 the stretcher is in equilibrium between said front loading carriage 4 and the additional rear support leg 9.

Then the operator effortlessly pushes the stretcher 1 in the above configuration into the ambulance: obviously, for the rear leg 9 to fold against the upper frame 2, the locking system 10 shall be first unlocked.

An inverse procedure shall be followed to unload the stretcher 1 from the ambulance.

The additional rear leg 9 may be also fixed to a crossmember of the frame 2 beneath the platform 2 and two rear legs can be also fixed to the stretcher 1 using a scissor-lift system, without departure from the scope of the present invention.

Particularly referring to FIGS. 6, 7, 8, 9, 10, 11, 12 and 13, there is shown an alternative solution for loading the stretcher 1.

A hook-like coupling system/device 50 is shown, which projects out of the floor 60 and engages with a corresponding loop formed on an extension 51 of the stretcher 1.

Thanks to this motor-driven device 50, the stretcher 1 is first coupled thereto (FIG. 6) and then conveniently rolled over the floor 60: at the same time, the rear leg 9 will stabilize the stretcher as described above.

The device 50 allows automatic or semiautomatic loading and unloading.

The device 50 may be a hook or an equivalent means attached to a pull rope.

The stretcher 1 of the above example includes mechanical, electro-mechanical, pneumatic or hydraulic means for folding or opening the scissor-lift 8 and moving the frames 2 and 4 close to or apart from each other.

1. Stretcher (1) for ambulances, of the type comprising:
a. an upper frame (2) with an optionally tiltable platform (3) mounted thereto;
b. a front loading carriage (4) fixed to the upper frame (2) through a suitable adjustment disk (3a) for adjusting the tilt of the front carriage (4), which has a pair of loading wheels (5) mounted thereto;
c. a lower frame (6) with free transfer wheels (7) mounted thereto;
d. a scissor-lift (8) that connects said lower frame (6) to the upper frame (2);
e. means for locking the lower frame (6) to the upper frame (2);
characterized in that it has at least one additional leg (9) and a corresponding support (10) for holding said leg (9) against the upper frame (2), to cause the stretcher (1) to be suspended between the front loading carriage (4) and the additional leg (9) during loading and unloading.

2. A stretcher (1) for ambulances as claimed in claim 1, characterized in that the support (10) is composed of a rod (10b) sliding in a corresponding cylinder (10a) and both are locked by suitable lock means, which may be of the manual, mechanical, hydraulic or electric type.

3. A stretcher (1) for ambulances as claimed in claim 1, characterized in that each additional leg (9) is directly hinged to the upper frame (2) or also to a crossmember of the frame (2) beneath the platform (3).

4. A stretcher (1) for ambulances as claimed in claim 1, characterized in that each additional leg (9) is equipped with at least one loading wheel (9a) at the end of said leg (9) for transferring the stretcher 1.

5. A stretcher (1) for ambulances as claimed in claim 1, characterized in that said leg is placed at the rear.

6. A stretcher (1) for ambulances as claimed in claim 1, characterized in that said loading and unloading steps are carried out manually by an operator.

7. A stretcher (1) for ambulances as claimed in claim 1, characterized in that said loading and unloading steps are carried out automatically, using a coupling system/device (50) which projects out of the floor (60) and engages a corresponding loop formed on an extension (51) of the stretcher (1); the device (50) being a motor-driven device.

8. A stretcher (1) for ambulances as claimed in claim 1, characterized in that it includes mechanical, electro-mechanical, pneumatic or hydraulic means for folding or opening the scissor-lift (8) and moving the frames (2) and (6) close to or apart from each other.
